(19) United States
(12) Patent Application Publication
(10) Pub. No.: US 2008/0216962 A1
(43) Pub. Date: Sep. 11, 2008

(54) Bead alignment clip and system for its use for locating and maintaining a tire bead positioning onto a tire core build man-drel in forming a core for manufacturing an elastomeric tire

(76) Inventors: Richard A. Steinke, Boulder City, NV (US); Gary N. Benninger, West Bloomfield, MI (US)

Correspondence Address: M. REID RUSSELL, 854 WEST 3390 SOUTH, HURRICANE, UT, 84737, US

(21) Appl. No.: 11/715,791

(22) Filed: Mar. 9, 2007

(51) Int. Cl. B29D 30/24

(52) U.S. Cl. 156/414

(57) ABSTRACT

The invention provides tire bead alignment clips for mounting onto each of a pair of tire beads have a U shape to fit over and clamp onto the tire bead that has received a plies sleeve end folded thereover and each tire clip is for magnetic attachment to each of a like number of spaced permanent magnets that are individually secured, at equal spaced locations, to points along radial arcs taken from a center of each of the sides of a cavity mold that are secured to opposite sides of a tire core build mandrel, and the permanent magnets are like horseshoe magnets having a pair of legs that each have north and south pole ends, and each bead clip side is magnetically attractive to couple to which permanent magnet ends, providing for attaching the plies sleeve ends and tire beads to optimum locations on opposite side of the cavity mold side inner surface and spaced apart from the tire core build mandrel that is for use in building a tire core to receive an elastomeric material directed therearound in a tire formation process.

### BACKGROUND OF INVENTION

1. Field of The Invention

This invention pertains to an apparatus and system for properly positioning and maintaining tire beads, with a tire plies fitted thereto, onto opposite sides of a tire core build mandrel in a process of building a tire core that is for fitting in a cavity mold for casting or molding an elastomeric tire.

2. Prior Art

The present invention is in an apparatus and system for use in the positioning of each of a pair of steel tire beads that ends of a tire plies sleeve have been folded around, and where the beads are positioned at desired location to the sides of a tire core build mandrel. Which positioning involves magnetically seating each bead to an inner surface of a side of a cavity mold where the sides are for installation onto the tire core build mandrel, such that, after the tire core is cast or molded into a tire, the beads, that are wrapped with the plies sleeve ends, will be perfectly positioned in the finished tire.

Tire bead clips formed from a magnetically attractive material are provided for mounting the tire beads at locations adjacent to the tire core build mandrel sides that are fitted, at equal spaced intervals, across each tire bead whereover a plies sleeve end has been folded. Each bead clip is for fitting onto the bead after the plies sleeve has been fitted over a crown surface of the tire core build mandrel, with the beads each slid over the outer surface of each of the plies sleeve ends, and the plies sleeve ends folded around each of the pair of beads.

The individual tire bead clips are formed from a magnetically attractive material and have sides that extend parallel to, and at essentially right angles from, opposite edges of a web, wherefrom legs separated from the clip sides by slots also extend, and which sides and legs are spaced appropriately apart to, when flexed, fit over and clip onto a tire bead whereto a plies sleeve end has been positioned. Which bead clip sides each include a flat section that is to receive ends of a horseshoe magnet, coupling thereto. The clip web, between the clip sides and legs top ends, spans the bead, and the legs, above the leg ends, have toes that are formed to flex outwardly for passing over the bead surface, and the clip sides ends are preferably out turned.

The preferred permanent horseshoe magnets are individually secured, at equal spaced intervals, around inner surfaces of cavity mold sides, facing inwardly therefrom, and each magnet has two ends that have both north south poles. The magnet ends thereby provide a strong holding force to maintain a flat side section of the clip fitted onto the plies sleeve end covered tire bead. In practice, such tire bead can be formed of steel and is itself magnetically attractive, or can be formed from an inelastic non metal material, such as a graphite fibers, or the like.

The individual magnets are positioned at equal spaced intervals around, and at equal radial distances outwardly from, the center of each of the cavity mold sides. Which cavity mold sides are for axially fitting to the tire core build mandrel sides, at the centers of the hub plates. The magnet equal distance spacing is duplicated as spaced longitudinal lines formed in the tire plies sleeve. So arranged, by folding the ends of the tire plies sleeve around the bead, such that each of the plies sleeve longitudinal lines is folded upon itself, and with the fitting the legs of each bead clip over the bead at the aligned plies sleeve longitudinal lines, the bead clips will be line up with the magnets to magnetically couple thereto. So arranged, each bead will be at an optimum position to the tire core build mandrel side, and will remain there during the tire core formation process.

The bead clips remain buried in the finished tire, with only the bead clip flat side as was coupled to the magnet exposed in the tire exterior wall at the rim engaging end. Additionally, to maintain a desired off-set of each of the beads from the interior surface of the cavity mold side interior wall and spaced from each of the surfaces of the core build mandrel sides, essentially centering each bead in the tire rim engaging ends, spaced posts are preferably arranged to extend at right or normal angles outwardly from the interior surfaces of the cavity mold sides. Which pins align to and engage the bead when the bead clips are magnetically attached to the permanent magnets, and the cavity mold sides are installed onto the tire core build mandrel opposite sides. The posts provide a proper stand-off distance to allow for a free flow of elastomeric material, preferably a polyurethane material, around the bead in the tire casting or molding process. The posts can be steel pins that are attached at spaced intervals to extend from the cavity mold sides and are pulled out of a finished tire when the tire is pulled out of the mold, or the pins can be formed of a material that is compatible with the elastomeric material, such as a pre-cure polyurethane, and are for fitting into spaced holes in the cavity mold sides to be pulled therefrom and remain as part of the finished tire that are then trimmed to be flush with the tire inter surface after tire removal from a mold.

Heretofore, in forming an elastomeric tire by molding or casting methods, the location of tire beads with ends of a tire plies folded thereover, and its placement onto sides of a tire core build mandrel has been labor intensive. A first effort at such bead mounting is shown in a U.S. Pat. No. 7,094,303 by one of the present inventors, entitled: “Method and Apparatus for Forming a Core of Plies, Belts and Beads and for Positioning the Core in a Mold for Forming an Elastomeric Tire”, Issued Aug. 22, 2006. The patent shows a plies sleeve being slid over a plies sleeve expander cone and positioned across a tire build mandrel and with tire beads slid over the plies sleeve ends for positioning onto the build mandrel sides and with the plies ends manually folded over the positioned beads. Additionally, a plies sleeve expander cone is shown utilized in another patent application of one of the inventors entitled a “Method and Apparatus for Vacuum Forming an Elastomeric Tire”, Ser. No. 10/936,635, filed Sep. 4, 2004. This U.S. Patent and patent application demonstrate a utilization of a plies sleeve that is slid over a plies sleeve expander cone and receives bead centering plates slid into the plies sleeve ends to capture each of a pair of beads as have been slid from the ends along the plies sleeve outer surface, catching each bead with the plies sleeve end bent around the bead and moving it onto the side of the tire core build mandrel. Thereafter, spacing layers and belts are applied over the plies sleeve top or crown surface, completing the tire core formation process. Which tire core is then positioned in a mold cavity for casting or molding a tire.

While such earlier systems and apparatus have been effective in building a tire core of plies, belts and beads, these early systems were labor intensive, and required a high level of skill to produce a core where the beads and plies were properly positioned in a formed tire. The present invention greatly simplifies the plies sleeve and beads mounting over such earlier systems.

### SUMMARY OF THE INVENTION

It is a principal object of the present invention to provide a simple and efficient system for positioning each of a pair of tire beads that have received ends of a plies sleeve folded therearound, to sides of a tire core build mandrel in a formation of a tire core of plies, beads and belts that is for positioning in a cavity mold for forming an elastomeric tire.

Another object of the present invention is to provide a system of permanent magnets that connect to magnetically attractive tire bead clips, where the permanent magnets are secured, at equal spaced intervals, to extend outwardly from around inner surfaces of each of the sides of a cavity mold to magnetically connect to magnetically attractive bead clips formed with opposing sides and legs to fit over and pinch onto a plies sleeve end folded over a tire bead, and which bead clips include flat side surfaces that are each for engaging and magnetically connecting on to one of the magnets, holding the bead thereto during an elastomeric tire casting or molding process.

Another object of the present invention is to provide an arrangement for positioning the bead clips over the plies sleeve ends where the clips will have the same spacing as the permanent magnets that are secured onto, to extend outwardly from, the cavity mold sides, enabling a quick and easy fitting of the tire beads mounting the plies sleeve ends into position adjacent to the sides of the tire core build mandrel.

Another object of the present invention is to provide an arrangement of equal spaced pins that are mounted to extend outwardly from the cavity mold sides and whose ends will engage the bead through the plies sleeve when the plies sleeve covered bead is secured, by its bead clips, onto the permanent magnets, allowing for a flow of the elastomeric material around the tire beads during tire casting or molding.

Still another object of the present invention is to provide a pin system where the individual pins are fixed to extend outwardly from the cavity mold sides such that, in a removal of the finished tire, the tire outer surface at each of the beads is pulled off from the pins, leaving small holes only.

Still another object of the present invention is to provide a pin system where the individual pins are formed from a material, such as a pre-cure elastomer, to be cast into the finished tire and are arranged for fitting into recesses in the cavity mold sides to be removed therefrom with the finished tire and then be trimmed to be flush with the tire outer side wall surfaces.

Still another object of the present invention is to provide, horseshoe permanent magnets as the individual magnets that have north and south poles on each of the two horseshoe ends that, for their weight and size, provide a very strong magnetic force to grip and hold the tire beads in place through the thickness of the plies sleeve during tire core assembly, and during positioning of the tire core build mandrel into the cavity of the cavity mold.

The present invention is in a system of permanent magnets and magnetically attractive tire bead clips for use together in fitting and maintaining a tire bead to sides of a tire core build mandrel, with each tire bead spaced apart from an inner surface of a cavity mold side and a hub plate of a tire core build mandrel to allow for a free flow of an elastomeric material passed therein during formation of a tire core after installation of the tire core in a cavity of a mold for casting, molding or vacuum forming an elastomeric, tire, preferably a polyurethane tire. The magnetically attractive bead clips are fitted, at equal spaced intervals corresponding to the magnet placement, onto the bead, clamping to the plies sleeve ends folded thereover. To provide which bead clip spacing, equal spaced longitudinal lines or stripes are preferably formed in the sleeve that the bead clips are aligned with. The bead clips each include a flat top web and essentially identical flat parallel sides, with one flat side to receive pole ends of a permanent magnet. So arranged, an operator installs the bead clips to sandwich the plies sleeve onto the bead, with one of the bead clip sides facing outwardly and is parallel the tire core build mandrel. The operator then moves the side of the cavity mold towards the side of the tire core build mandrel and presses each of the bead clips flat side surfaces onto the poles of each of the permanent magnets that are secured to inner surface of sides of a cavity mold. The permanent magnets each hold a plies sleeve end wrapped bead in place during the cavity mold sides installation to the tire core build mandrel, and which bead clips will remain in the finished tire outer side walls after tire casting or molding.

Further, to provide for proper centering of each bead in the tire side wall ends, pins, that are either permanent or are removable from the cavity mold side, are installed, at spaced intervals in the cavity mold sides, projecting inwardly, with the pin ends to engage the tire bead, at spaced intervals therearound, when the tire bead clips are fitted to the magnets, and the cavity mold sides are fitted into place to the sides of the tire core build mandrel, allowing for passage of the elastomeric material around the tire beads in the tire molding or casting process. Which combination of bead clips, off-setting pins and permanent magnets greatly simplifies bead installation in the tire core formation process over early systems.

Preferably, eight (8) magnets, but as few as six (6) magnets per side of the tire core build mandrel, are secured, at equal spaced intervals of approximately forty five (45) degrees for the eight (8) magnets, around each side of the cavity mold sides to be opposite to an optimum location of a tire bead to each of the build mandrel sides. The permanent magnets are preferably horseshoe magnets that are each formed as a sandwich of a core of magnetic material, such as neodymium iron boron magnetic material, sandwiched between poles formed from steel, providing a magnet with positive and negative poles at each horseshoe end that are in a plane that is parallel to the tire core build mandrel sides. The individual U shaped bead clips are formed from a magnetically attractive material, such as steel, and have a flat web outer surface between oppositely essentially flat parallel sides that each flat sections to accommodate the pair of magnet poles. Flexing legs extend downwardly from the ends of the rectangular section, spaced apart by slots in the side sections. The bead clip is preferably formed from light gauge steel to allow for bead clip side and leg flexure and to be magnetically attractive to the permanent magnet, coupling to the ends of the horseshoe magnet legs.

The bead clip flexing legs each include a dog leg bend, and are space apart to allow for their passage across the tire bead that has been wrapped with an end of a plies sleeve. In which fitting of the bead clips onto the bead plies wrapped out surface, one of the clip flat sides outer surface is aligned with, to magnetically attach, to the pole ends of a permanent magnet mounted so as to extend outwardly from the inner surface of a cavity mold side. To provide for a proper spacing of the bead clips around the tire bead, maintaining the plies sleeve end folded across which tire bead, the plies sleeve preferably includes longitudinal stripes or lines, that can be painted thereon or can be formed by threads woven in the plies sleeve, at space intervals therearound that conform to the spacing between the respective permanent magnets that are attached to each side cavity mold that receives the tire core build mandrel installed therein.

In practice, an operator pulls the plies sleeve along a plies sleeve expander cone that is fitted onto the tire core build mandrel to approximately a mandrel top or tread center. The plies sleeve is pulled across the mandrel top to where the plies sleeve opposite ends are approximately equidistant from the tire core build mandrel center. Tire beads are then slid over the plies sleeve ends to where each bead approximately aligns with the preferred bead location alongside the build mandrel, centered on the hub plate, and the plies sleeve ends are folded over each of the tire beads. Bead clips are then individually aligned with each of the sleeve longitudinal lines and the bead clip opposing sides are fitted over the plies sleeve covered beads such that the a flat side of each clip faces outwardly. So arranged, in the installation of the cavity mold sides to the tire core build mandrel hub plate, the ends of the permanent magnets that extend inwardly from each of the cavity mold sides aligns with, and are pressed against, each of the clip sides. In which pressing, the horseshoe shaped permanent magnets ends, that each include north and south poles, engage and magnetically attach to the bead clip sides, holding a tire bead thereto.

For holding each of the beads away from both the cavity mold sides and above tire core build mandrel hub, pins are provided that extend at spaced intervals from the cavity mold sides that will pass through the plies sleeve and engage the tire bead, holding the bead away from the cavity mold sides and apart from tire core build mandrel sides, centering the tire beads in the cavity ends, to allow for a free passage of the elastomeric material therearound in the tire formation process. The tire beads are thereby centered between the finished tire inner and outer walls and the side wall rim engaging ends.

In practice, the pins can be formed from metal, such as steel, and are fixed to extend outwardly from each cavity mold side, and with each pin to align with a tire bead that is magnetically secured at its bead clips onto each of the magnets of the cavity mold sides, holding the tire bead off of with cavity mold sides, centering it in the mold cavity ends. Alternatively, the pins can be formed from a material that is compatible with the elastomeric material, preferably a polyurethane, that is used to cast the tire and with the pins fitted into holes formed in the cavity mold sides to be pulled therefrom, remaining in the tire outer side walls ends for later trimming to be flush with the tire inner side wall surface. In practice, a material that is compatible with the preferred polyurethane material is a pre-cure urethane.

### DESCRIPTION OF THE DRAWINGS

The invention may take physical form in certain parts and arrangement of parts used to mount ends of a tire plies sleeve to each of a pair of tire beads and to maintain the plies sleeve and tire beads between a cavity mold side and the tire core build mandrel sides is shown as a preferred embodiment that will be described in detail in this specification and is illustrated in the accompanying drawings which form a part hereof:

FIG. 1 shows an exploded side elevation perspective view of a tire core build mandrel that includes hub plates mounted onto opposite sides thereof, shows the tire core build mandrel axially aligned with a plies sleeve expander cone that has a wide open end that is fitted over the build mandrel side to the center of the build mandrel top surface and shows a plies sleeve that is aligned for fitting over a smallest plies sleeve expander cone end to travel therealong and over the tire core build mandrel, and which plies sleeve is shown to include equal spaced longitudinal stripes, shows a pair of tire beads positioned between the build stand and the tire core build mandrel and aligned for fitting over the plies sleeve end, and with tire bead clips shown positioned at equal spaced intervals alongside of each of the beads;

FIG. 2 is an enlarged side elevation perspective view of the tire core build mandrel mounting hub plates to opposite sides thereof, and showing the plies sleeve slide thereover, with tire beads shown as having been passed over the plies sleeve ends and with which plies sleeve ends shown as having been folded around the tire beads, illustrated by arrows A, and with tire bead clips shown aligned, at equal spaced intervals, to one of the tire beads for passage over the tire bead, clamping the plies sleeve thereto;

FIG. 3 is a view like that of FIG. 2 only showing each plies sleeve ends as having been folded over a tire bead and showing eight equal spaced bead clips fitted across the bead, clamping the plies sleeve end onto the tire bead with the plies sleeve end covered bead fitted across a shoulder of the tire core build mandrel hub plate, and showing sides of each tire bead clips as having a flat side surface that faces outwardly;

FIG. 4 is a side elevation view perspective view of a pair of mold cavity sides that are center mounted to slid along opposite ends of a rod that has been fitted through the tire core build mandrel hub plate, and showing the mold cavity side inner surface as mounting eight equal spaced horseshoe magnets that are installed at equal spaced intervals to extend outwardly from the side inner surface to align each magnet ends to with each of the tire bead clips, and with pins shown extending from the mold cavity sides, alongside of and spaced apart from the permanent magnets;

FIG. 5 is side elevation expanded sectional view of the tire bead whereover a plies sleeve end has been wrapped and showing a bead clip fitted thereto, showing a section of the cavity mold side wherefrom a horseshoe magnet extends with its legs engaging and magnetically connecting to a bead clip side, holding the plies sleeve covered tire bead in position, and showing pins on opposite sides of the horseshoe magnet that extend from the cavity mold side such that the pin ends contact the tire bead;

FIG. 6A is a side elevation view of a section of the tire core build mandrel fitted within a cavity mold and showing the tire bead with an end section of the plies sleeve folded thereover and maintained by the bead clip, with the bead clip flat side outer surface shown as magnetically attached to the ends of legs of a horseshoe magnet that extends outwardly from the cavity mold side and showing, in broken lines, one of the pins as extending outwardly from the cavity mold side and spaced apart from the horseshoe magnet along a same radial arc as the horseshoe magnet occupies, and which radial arc is for receiving the tire bead mounting the plies sleeve for forming the tire core, with the arc of which tire bead shown in broken lines and with the pin end shown as engaging the tire bead and showing a cavity mold crown fitted thereover;

FIG. 6B is a view like that of FIG. 6A only showing the tire formed from an elastomeric material in broken lines as a section that has been pulled away from the hub plate after removal of the cavity mold side;

FIG. 7A shows an enlarged end profile perspective view of one of the permanent horseshoe magnets removed from the cavity mold side, illustrating that the magnet is formed from laminated sections to have North and South poles at the end of each magnet leg;

FIG. 7B, shows a view like that of FIG. 7A with the sections that make up the permanent horseshoe magnet shown as exploded apart;

FIG. 8 shows an enlarged end side elevation perspective view of one embodiment of the pin of the invention;

FIG. 9, is a view like that of FIG. 8 only showing another embodiment of the pin of the invention;

FIG. 10 shows an enlarged side elevation perspective sectional view taken from one flat side of a magnetically attractive U shaped bead clip of the invention; and

FIG. 11 shows a side elevation view of the U shaped bead clip of FIG. 10.

### DETAILED DESCRIPTION

The invention is in a magnetically attractive tire bead alignment clip and an arrangement of magnets secured to a cavity mold side that is arranged for coupling to a hub plate of a tire core build mandrel. The tire core build mandrel is for forming a tire core for installation in the cavity mold, with the magnets mounted to the cavity mold sides for magnetically coupling to each of the bead clips that have been fitted across a tire bead that a plies sleeve end has been folded over. The combination of permanent magnets and tire bead clips provides for maintaining a pair of tire beads properly positioned between opposite sides of the tire core build mandrel and the cavity mold sides in the formation of a tire core. Which tire core is then positioned in a mold for molding, casting or vacuum forming a polyurethane tire therearound similar to the arrangement set out in the earlier U.S. Pat. No. 7,094,303 of one of the inventors, cited above.

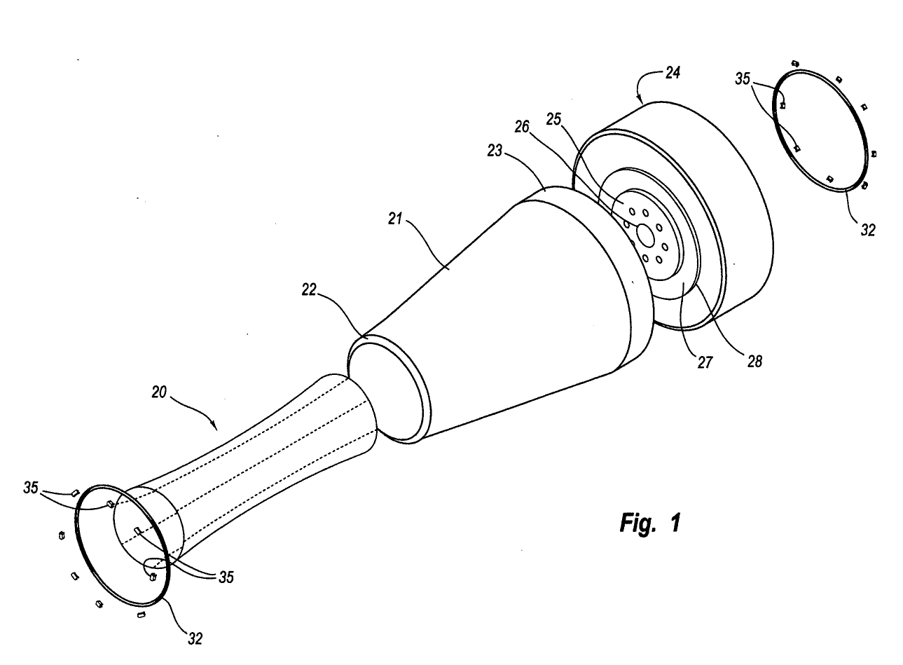

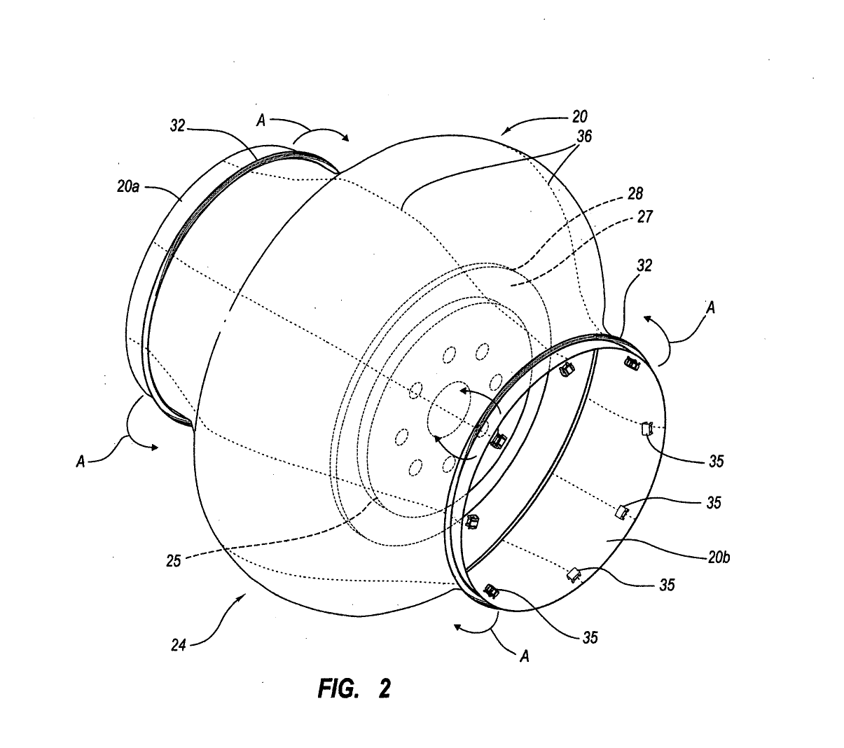

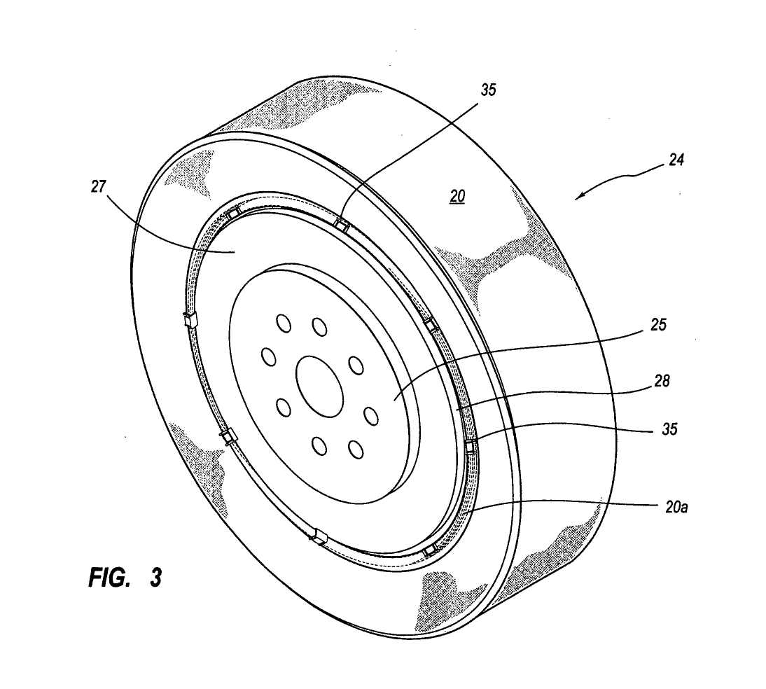

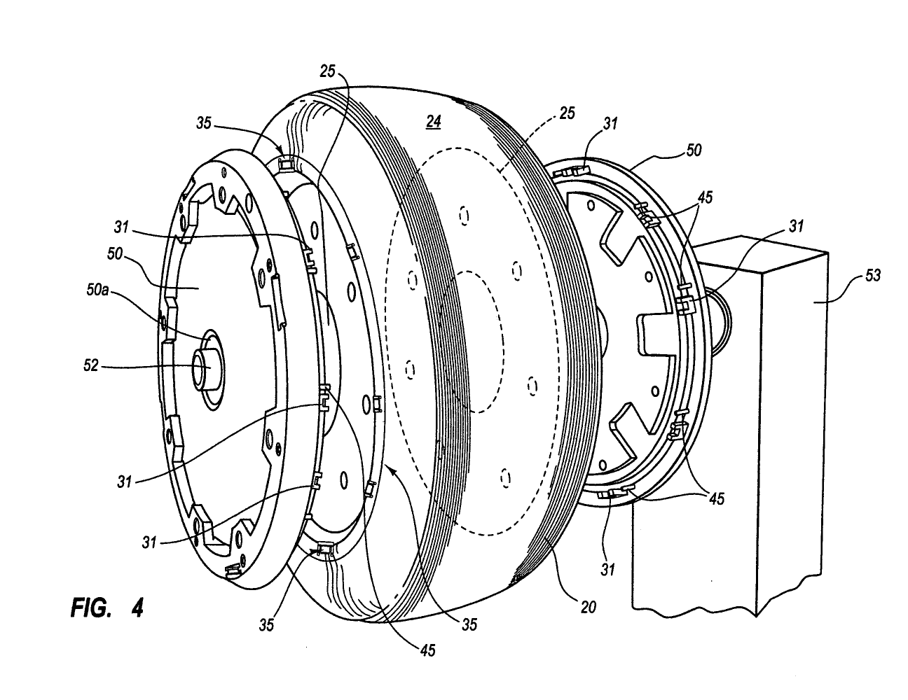

The present invention in an arrangement of tire bead clips and permanent magnets for positioning and maintaining a tire bead in a tire core for positioning in a mold cavity for forming a polyurethane tire. As shown in FIG. 1, a plies sleeve 20 is fitted onto a lesser diameter end 22 of a plies sleeve expander 21 to travel along and off of a greater diameter end 23 and across a tire core build mandrel 24. Which tire core build mandrel 24, like the tire core build mandrel of U.S. Pat. No. 7,094,303, is a preferred and is assembled from tire core segments that are fitted together into a donut shape and includes a pair of mirror image center hub plates 25 that include center openings 26 that are for receiving an axle, as shown in FIG. 4, fitted therethrough and through sides 50 of a cavity mold. The center hub plates 25, as shown in broken lines in FIG. 2 and solid lines in FIG. 3, attach to opposite sides of a tire side wall end formation plate 27 of the tire core build mandrel whose outer edge 28 blocks a flow of elastomeric material in forming a tire side wall end.

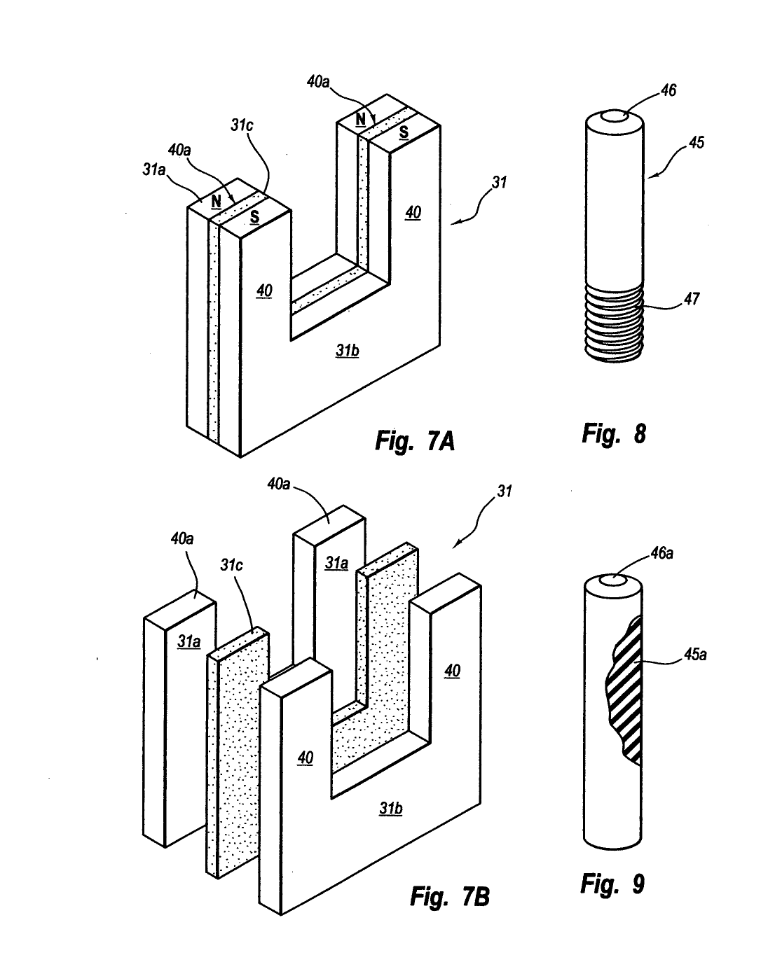

As shown in FIG. 4, the pair of cavity mold sides 50 are identical and each includes eight (8) permanent magnets 31 that extend outwardly from an inner surface 51 that are for alignment with each of the tire beads 32, as shown in FIGS. 1 and 2. It should, however, be understood that as few as six (6) magnets, can be included with each cavity mold side 50, within the scope of this disclosure. For the eight (8) permanent magnets 31 shown, they are individually secured, at equal spaced intervals of approximately forty five (45) degrees, around each inside face to be opposing the tire core build mandrel sides and hub plates 25 to be at an optimum location of a tire bead 32 that is for mounting within the cavity mold, alongside each of the tire core build mandrel sides. The permanent magnets 31 are each preferably horseshoe magnets that are each preferably formed as a sandwich of a core of magnetic material, such as neodymium iron boron magnetic material between poles formed from steel, providing a magnet with, as shown in FIGS. 7A and 7B, legs 40 between a web 31b, where the sandwich of magnetic material between steel provides North-South poles at the ends 40a of each horseshoe leg 40 that are in a plane that is parallel to the inner surface 51 of the cavity mold sides 50.

FIG. 2 shows the tire core build mandrel 24 that has had the plies sleeve 20 passed over the tire core build mandrel top surface, and is centered between the build mandrel sides. Thereat, plies sleeve ends 20a and 20b ends are shown as being folded back across each of the beads 32, illustrated by arrows A, and shows bead clips 35 of the invention spaced apart from a right side of the build mandrel and aligned for fitting over the plies sleeve end 20b and bead 32, for clamping across the plies sleeve 20 end 20b to hold the plies sleeve end to the bead 32. For positioning the bead clips 35 at optimum positions, and at equal spaced intervals around the bead 32, each bead clip 35 is aligned with a longitudinal line 36, shown as spaced broken lines, that are preferably formed in the plies sleeve weaving process. But may be separately scribed thereon within the scope of this disclosure. Which longitudinal lines 36 are spaced equidistantly from one another and provide a same number of lines as the number of permanent magnets 31 and bead clips 35.

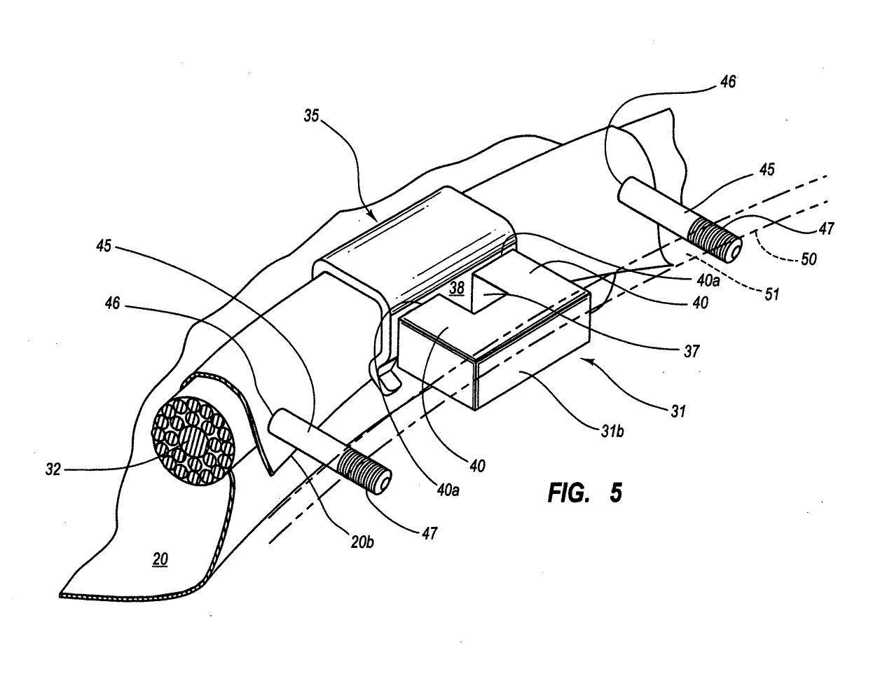

FIG. 3 shows the plies sleeve 20 end 20a as having been folded over the bead 32 and is clamped thereto by bead clips 35 that have sides 38 and with one of which sides 38 is positioned against, and magnetically held by, one of the permanent magnets 32, as shown in FIG. 4, and best in FIG. 5. Thereafter, the plies sleeve 20 receives a tire belt or belts, not shown, fitted thereto and then receives a final winding of a tire cord, not shown, to complete the manufacture of the tire core. Which tire core is then mounted in the cavity mold to receive a flow of an elastomeric material, preferably a polyurethane mixture, in a molding, casting or vacuum forming process, for forming a finished urethane tire 60, as shown in FIGS. 7A and 7B.

FIG. 4 shows cavity mold sides 50 with opposing inner surfaces 51 of each side 50 each including equal spaced permanent magnets 31 installed therein that project at right or normal angles outwardly from the sides inner surfaces. Which permanent magnets are located at equal distances outwardly along radials that extend from the center of each cavity mold side 50, with for the eight (8) permanent magnets 31 as are preferred, the radials are at forty five (45) degree angles from one another. FIG. 4 also shows the cavity mold sides 50 as including a center opening 50a for fitting over an axle 52 that extends through each of the hub plates 25 that are fitted onto the center of the tire core build mandrel 24, and which axle 52 is shown as fitted to, to extend outwardly from, a stand 53. Further, spaced pins are shown at spaced intervals alongside and between the permanent magnets 31 at the same radial distances outwardly from the cavity mold sides center for engaging the bead as is magnetically attached to the permanent magnets as shown in FIG. 5.

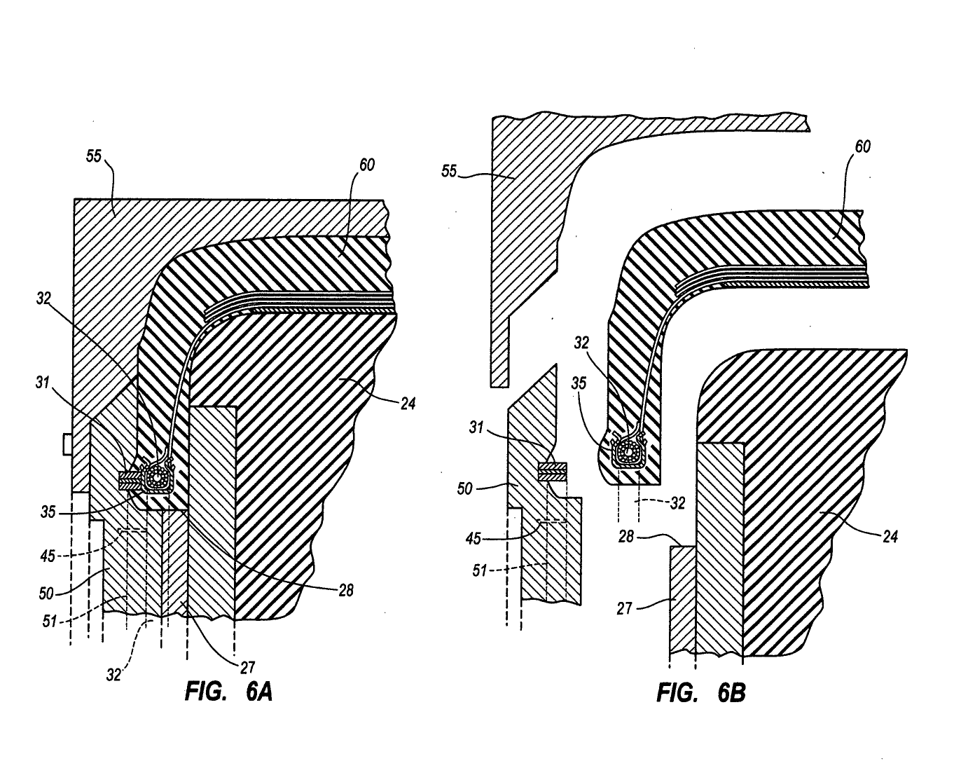

FIG. 5 shows an enlarged perspective view of a section of the bead 32 with an end 20b of the plies sleeve 20 folded therearound, and with a bead clip 35 connected along opposite straight edges of a flat web 37 to sides 38. The bead clip 35 is shown fitted across the plies wrapped bead such that a flat surface of the side 38 can be magnetically coupled to flat end surfaces 40a of horseshoe magnet 31 legs 40, the bead clips to grip and sandwich the plies sleeve 20 and plies sleeve end 20b against the tire bead 32 surface. Additionally, pins 45, that are spaced at equal intervals from the permanent magnet 31, are shown with their flat top ends 46 in engagement with the bead 32. Which pins 45 are shown as having threaded ends 47 that are for turning into the mold cavity side 50 inner surface 51, as shown in FIGS. 6A and 6B. The pin 45 mounting in the cavity mold side 50 inner surface 51 is such that the pin flat end 46 will engage the plies sleeve surface 20, alongside of the bead clip 35 side 38. The pin 45 head or top end 46 maintains the alignment of the plies sleeve covered tire bead 32 surface with the side 38 of the bead clip 35, providing for optimum positioning of the tire bead within the tire side wall of a molded, cast or vacuum formed tire formed around the tire core. In practice, each of the bead clips 35 remains with the tire core of a finished polyurethane tire, and, when the finished tire is removed from the mold, the pins 45 are pulled out of the tire side wall, leaving small holes. Pins 45 are secured by turning their threaded ends 47 in tapped holes formed in the cavity mold side 50 inner surface 51, along the same arc, as illustrated in broken lines in FIG. 5, that the bead 32 conforms to, and which pins 45 are spaced equidistantly apart from one another and from the permanent magnets 31.

FIGS. 6A and 6B are side elevation view of a section of the tire core build mandrel 24, formation plate 27 with edge 28, cavity mold side 50 and cavity mold crown 55. The FIGS. 6A and 6B show a cross section of the bead 32 with an end section of the plies sleeve 20 folded therearound and maintained by the bead clip 35, with a bead clip flat side surface shown as magnetically attached to the ends of legs 40 of a horseshoe magnet 31 that extend outwardly from the inner surface 51, shown in broken lines, of the cavity mold side 50, and showing, in broken lines, one of the pins 45 as extending outwardly from the cavity mold side inner surface 51 that is spaced apart from the horseshoe magnet 31 along a same radial arc as the horseshoe magnet extends from. The bead 32 is positioned on which radial arc in forming the tire core, with the arc of which tire bead 32 illustrated in FIGS. 6A and 6B as a section and in broken lines, and with the pin 45 end shown as engaging the bead. A tire 50 formed from a polyurethane material is shown as a section in FIGS. 6A and 6B as having been molded, cast or vacuum formed over the tire core build mandrel 24 to contain the tire core. With, in FIG. 6B the formed tire 50 is shown being removed from the cavity mold and pulled off of the tire core build mandrel, and showing that the pins 45 and horseshoe magnets 31 remain secured to the mold cavity side 50 inner surface 51 after removal of the tire 50.

FIG. 8 shows the pin 45 of FIG. 5 to illustrate that the pin top 46 can, but need not be, be sloped from a flat center to the pin side, providing a force concentration at the pin center that engages the bead 32 through the plies sleeve 20, as shown in FIG. 5 and, of course, remains secured to the mold cavity side 50 inner surface 51 after removal of a formed tire 60, as shown in FIG. 6B. Additionally, where FIG. 8 illustrates a use of a pin 45 that is preferably formed from steel and is permanently fixed to extend from the inner surface 51 of the cavity mold side 50, a pin 45a is shown in FIG. 9 as having a like top face 46a and is shown as being smooth walled could be so used. Which pin 45a is preferably formed from a pre-cure elastomer, of other appropriate material, that will combine with the polyurethane material as is used to form the tire 60. The pin 45a is therefore arranged to be removable with the completed molded or cast tire 60 and accordingly each such pin 45a is fitted into a hole formed in the cavity mold side 50 inner surface 51, not shown, to be pulled therefrom along with the finished polyurethane tire 60 when the tire is removed from the cavity mold, and can then be trimmed off the tire side wall inner surfaces. It should be understood therefore, that a use of the pins 45 will leave small holes in the tire inner side wall ends while a use of the removable pins 45a will require that top ends of each pin 45a be cut or otherwise trimmed to a level attitude with the inner surface of the tire side wall ends.

FIGS. 7A and 7B show a preferred arrangement of the permanent horseshoe magnet 31 of FIGS. 4, 5 6A and 6B as being a laminate of a pair of front and rear sides 31a and 31b that sandwich a center section 31c of, preferably, a neodymium iron boron magnet material. The permanent magnet 31, as shown, includes like parallel legs 40 that have flat ends 40a that, respectively, form north and south poles, and with the pairs of north south poles separated by a web or saddle 31b. Which web or saddle 31b of each permanent magnet 31, as set out above, is mounted to extend outwardly from the inner surface 51 of the cavity mold side 50 such that their flat ends 40a that each contain north and south poles ends are in a same plane and are just above the cavity mold side 50 inner surface 51. So arranged, the permanent magnet ends 40a providing surfaces to engage and magnetically connect to a the top surface 37 of the bead clip 35. In practice, the permanent magnet 31 that is formed as a laminate of a center core of neodymium boron magnet material between steel plates and is formed into a horseshoe shape to provide for separate pairs of north and south poles as the permanent magnet 31 ends 40a. The horseshoe legs ends to thereby function as two separate magnets, one at each end 40a, to produce a single permanent magnet that has an attractive force that is two to three times greater than a single magnet could provide for magnetically coupling to a bead clip 35flat side surface 38, holding the bead clip and magnetically attached plies sleeve wrapped tire bead firmly in place.

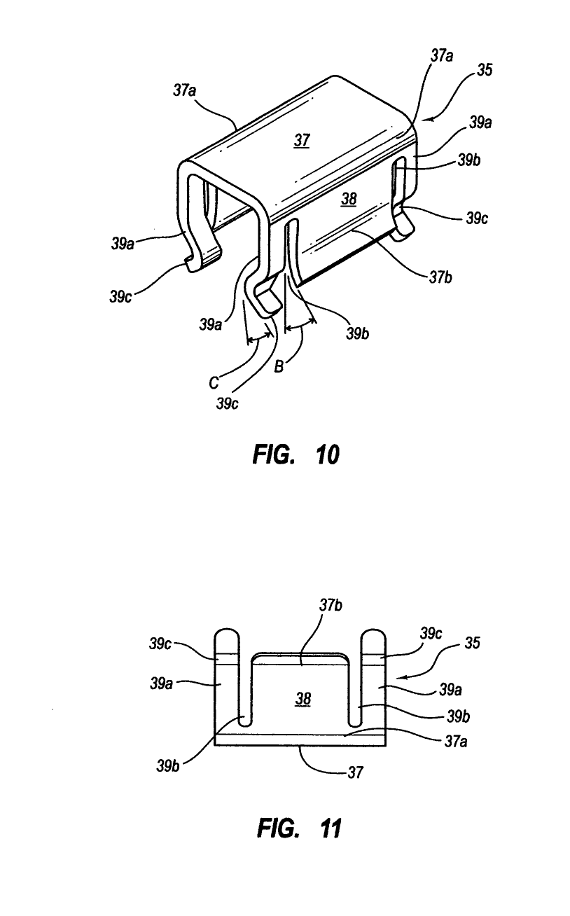

FIGS. 10 and 11 show preferred configurations of the bead clip 35 of the invention that is preferably formed of steel to be magnetically attractive to the permanent magnet 31, as set out above. The bead clips 35 includes the flat web top surface 37 that is rectangular in shape and includes legs or sides 38 that are formed at bends 37a along the opposite web sides. The bead clip 35 sides 38 each include a center section that is flat to receive and magnetically connect to ends 40a of permanent magnet 31, and which center section is separated from the bead clip end sections 39a by slots 39b. So arranged, the respective bead clip center and ends sections 39a can flex independently, each returning to its un-flexed attitude when a flexing force is removed. In practice, the bead clip 35 is urged over the plies sleeve 20 folded over the tire bead 32, as set out above. In that passage, the respective clip side and end sections 38 and 39a are flexed outward as their ends pass across a tire bead 32 axis and, after which passage, they relax against the tire bead 32 curved surface. To facilitate that bead clip 35 flexure, the clip side center section is bent at 37b across an outer section to curve outwardly from the center section at an angle B. Which angle B is preferably an angle of approximately thirty (30) degrees, but may be an angle in a range of angles of from fifteen (15) to forty (45) degrees, within the scope of this disclosure. Similarly, to facilitate passage of the clip end sections 39a a dog leg bent is formed in each end section 39a lower portion that provides an outwardly curve toe end 39c, shown as an angle C, that is an angle that the toe end 39c forms with the plane of the end section 39a. Which angle C is preferably a forty five (45) degree angle but may, in practice, be an angle of from thirty (30) to sixth (60) degree angle, within the scope of this disclosure. The bead clip 35 arrangement of flexing side 38 center and end sections provides for clamping the plies sleeve 20 end 20b onto the tire bead 32 and for magnetically coupling the bead clip side flat surface 38 to one of the permanent magnets 31.

In practice, with the plies sleeve 20 installed across the tire core build mandrel 24, as shown in FIG. 2, the ends 20a of the plies sleeve 20 are folded around the tire beads 32 and the individual bead clips 35 are aligned with each of the plies sleeve longitudinal lines 36. Thereat, the individual bead clips 35 are fitted over the plies sleeve end covered tire bead such that a bead clips side surface 38 faces the inner surface 51 of the cavity mold side whereon are mounted the equidistantly spaced permanent horseshoe magnets 31 and pins 45 or 45a, with the legs end surfaces 40a of each of the horseshoe magnets 31 legs 40 positioned to be essentially flush or just above the cavity mold side 50 inner surface 51. Each of the bead clip 35 side surfaces 38 is then pushed against the top surfaces 40a of the legs of one of the permanent magnets 31, magnetically attaching it thereto. With each bead clip 35, in turn, being so fitted to each of the spaced permanent magnets 31, the bead clips 35 hold the plies sleeve 20 wrapped tire beads 32 in place. In which connection, the pin 45 or 45a ends 46 or 46a engage and urge the plies sleeve 20 wrapped tire bead 32 away from the cavity mold side 50 inner surface 51, towards the a side of the tire core build mandrel, centering the tire bead 32 between which side inner surface 50 and side of the tire core build mandred, allowing for a free flow of a polyurethane material therearound during a formation of a tire contain the core of plies, beads and beads that includes the plies sleeve 20 and beads 32.

After tire formation, the cavity mold containing the tire core is broken apart and the bead clips 35 that are encapsulated in the tire side walls, adjacent to the beads 32, are pulled away from the build mandrel 24, with the tire bead clips side 38 pulling off of the permanent magnets ends 40a and the pins 45 pulling out of the formed tire, as shown in FIG. 6B. In which formed tire removal, the bead clips 35 remain in the tire, with each bead clip side 38 exposed in and is flush with the tire side wall end outer surface. When, however, the removable pins 45a are used, the pins 45a stay with the formed tire and can be cut off flush with the tire side wall inner surface.

Tire beads, of course, must be inelastic and have a high tensile strength to be effective in retaining a tire on a rim. Heretofore, steel wires twisted into cables have provided satisfactory tire beads and are commonly used. The invention in the tire clip and magnet combination for maintaining a plies sleeve end folded around a tire bead allows for a use of a tire bead formed from any appropriate material that will produce a tire bead that is inelastic and has a high tensile strength, and, in addition to steel, one such material for forming a tire bead could be twisted graphite fibers.

While a preferred embodiment of our invention in a bead alignment clip and system for its use with permanent magnets for locating and maintaining positioning of a tire bead onto a cavity mold side inner surface fitted over a side of a tire core build mandrel for forming a tire core by casting, molding, vacuum forming or otherwise manufacturing methods to form a transport tire around a tire core, has been shown and described herein, it should be understood that variations and changes are possible without departing from the subject matter coming within the scope of the following claims, and a reasonable equivalency thereof, which claims we regard as our invention.

We claim:

1. A tire bead clip and permanent magnet combination for aligning a tire bead to a side of a tire core build mandrel for use for forming a tire core for molding, casting or vacuum forming an elastomeric tire comprising, a plurality of like U shaped tire bead clips that are each formed from a flexible magnetic metal that includes a rectangular web with flat sides extending downwardly and parallel to one another from along opposite long sides of said rectangular web, forming right angles thereto, and with said tire bead clip sides to flex outwardly to pass across a steel tire bead that a plies sleeve end has been folded over and to un-flex, to tightly grip said tire bead and plies sleeve end; and a plurality of like permanent magnets that individually attach to opposite sides of a cavity mold that contains the tire core build mandrel that are center mounted through opposite centers of the tire core build mandrel and said permanent magnets are individually secured at equidistant points along arcs that are identical radial distances out from centers of said cavity mold sides inner surfaces and are spaced to correspond to locations of each said tire bead clip clamped over said plies sleeve end and tire bead with each said tire bead clip to magnetically attach to each of said permanent magnets, holding said tire bead with said plies sleeve end folded thereover properly positioned between said cavity mold sides and sides of said tire build mandrel during formation of an elastomeric tire in a cavity mold.

2. The tire bead clip and permanent magnet combination as recited in claim 1, wherein each tire bead clip side is slotted adjacent to its ends to form legs that extend from said tire bead clip rectangular web corners, and each said side has a flat center section above an outwardly curved lower edge, and which said legs are bent outwardly from the plane of each said end section, forming toe ends.

3. The tire bead clip and permanent magnet combination as recited in claim 2, wherein each tire clip side lower edge is bent outwardly at an angle of from fifteen (15) to forty five (45) degrees to the plane of said center section, and each side section toe end, below the bend, forms an angle of from thirty (30) to sixty (60) degrees to the plane of said end section.

4. The tire bead clip and permanent magnet as recited in claim 1, wherein each permanent magnet is formed in a horseshoes shape and is a laminate of a center section of a permanent magnet material sandwiched between steel sections, and with the ends of each horseshoe leg having both north and south poles, and a web of said permanent horseshoe magnet is arranged for mounting to the cavity mold side inner surface.

5. The tire bead clip and permanent magnet as recited in claim 4, wherein the permanent magnet center section is formed from a layer of a neodymium iron boron magnet material.

6. The tire bead clip and permanent magnet as recited in claim 1, wherein eight (8) permanent magnets are mounted to extend outwardly from the inner surface of each of the cavity mold sides and are space at approximately forty five (45) degree intervals from one another; and a like number of tire bead clips are provided for magnetic attachment of each of plies sleeve end to the tire bead, maintaining the tire bead and plies sleeve between said cavity mold side inner surface and the tire core build mandrel side.

7. The tire bead clip and permanent magnet as recited in claim 1, further including equidistant space parallel longitudinal lines formed in the plies sleeve ends whose spacing reflects the spacing of the permanent magnets as are secured to the inner surface of each of the cavity mold sides.

8. The tire bead clip and permanent magnet as recited in claim 7, wherein the space parallel lines are formed by weaving threads into the plies sleeve during a plies sleeve weaving process.

9. The tire bead clip and permanent magnet as recited in claim 1, wherein each tire bead clip is fitted over the plies sleeve end folded over the tire bead such that an outer surface of a side off the tire bead clip faces the ends of one of the permanent magnets to magnetically attach thereto in a formation of the tire core.

10. The tire bead clip and permanent magnet as recited in claim 9, further including pins that are individually spaced apart and are arranged at intervals in the inner surface of each cavity mold side to extend outwardly at right angles from said cavity mold side inner surface, alongside of the permanent magnets, and are spaced at intervals along the same radial arcs, and at equal spacing distances between said permanent magnets.

11 The tire bead clip and permanent magnet as recited in claim 10, wherein the pins are formed from metal and are fixed to extend at right angles outwardly from the inner surface of each of the cavity mold sides.

12. The tire bead clip and permanent magnet as recited in claim 10, where the pins are formed from a pre-cure elastomer that is compatible to, and will cure with, the material as is used to form a tire containing the tire core, and which said pins are for individual positioning in each of spaced holes formed into the inner surface of each of the cavity mold sides, between the spaced permanent magnets.

13. A system for positioning and attaching a tire bead that has received a tire plies sleeve folded thereto onto a tire bead mounting location on an inner surface of the sides of a cavity mold, where each said cavity mold side is fitted to a tire core build mandrel, forming a cavity between said cavity mold side and a sides of said tire core build mandrel comprising the steps of, fitting a plies sleeve over a top or tread area of a tire core build mandrel that includes a pair of like center hub plates secured to opposite sides thereof, and where said plies sleeve has a length to provide ends for folding across each of a pair of tire beads and folding said plies sleeve ends over each of said tire beads; fitting tire bead clips over said plies sleeve and tire bead, clamping said plies sleeve ends to each of said tire beads and each said tire bead clip is formed from magnetically attractive steel and each includes a flat rectangular web with parallel sides projecting at right angles from opposite long sides of said web section that will flex outwardly to pass over the plies sleeve end folded over said tire bead; positioning said tire bead clip over to grip said plies sleeve end covered tire bead such that a tire bead clip side faces outwardly for receiving ends of one of a number of permanent horseshoe magnets that are individual mounted at equal spaced distances around a center of each of the cavity mold sides inner surfaces, and which said permanent magnets magnetically attach to, provide an optimum positioning of said tire plies sleeve end and tire bead onto said cavity mold side inner surface, alongside and spaced apart from the tire core build mandrel side.

14. The system as recited in claim 13, further including longitudinally lining the plies sleeve at the same spaced intervals as the equal spaced intervals between the permanent magnets.

15. The system as recited in claim 14, wherein the longitudinal lining is provided by weaving longitudinal threads in the plies sleeve during the process of weaving said plies sleeve.

16. The system as recited in claim 13, further including, straight pins are fitted into each cavity mold side inner surface alongside, and space equal distances from, the spaced permanent magnets, and which said pins are alike and are of a length to engage the tire bead through the plies sleeve that has been mounted by the tire bead clips to each of the permanent magnets to maintain a desired spacing distance of the tire bead between the mold cavity side inner surface and the tire core build mandrel side so as to allow a flow of the elastomeric material therearound.

17. The system as recited in claim 16, wherein the straight pins are formed from steel and are fixed to the mold cavity side inner surface at their bases, to be pulled out of the formed elastomeric tire side wall inner surface when the elastomeric tire is removed from the cavity mold wherein it has been formed.

19. The system as recited in claim 16, wherein the straight pins are formed from a material to cure with the elastomeric material as is used in the tire formation process and said pin bases are fitted into holes formed in mold cavity side inner surface to pull therefrom as part of the formed elastomeric tire; and said pins are trimmed flush to said elastomeric tire side wall inner surface.
